(19) United States
(12) Patent Application Publication
(10) Pub. No.: US 2015/0351201 A1
(43) Pub. Date: Dec. 3, 2015

(54) SYSTEM AND METHOD FOR SELECTING MEMBERS OF A LIGHTING SYSTEM

(71) Applicant: TRIDONIC GMBH & CO KG, Dornbirn (AT)

(72) Inventor: Simon PRIOR, Zurich (CH)

(21) Appl. No.: 14/653,836

(22) PCT Filed: Dec. 19, 2013
(86) PCT No.: PCT/AT2013/000205

§ 371 Date: Jun. 18, 2015

(30) Foreign Application Priority Data
Dec. 21, 2012 (DE) 102012224147.7

(51) Int. Cl. H05B 37/02

(52) U.S. Cl. CPC H05B 37/0254; H05B 37/0272

(57) ABSTRACT

The invention relates to a system or method that uses a sensor (1) coupled to the line of sight. The sensor (1) coupled to the line of sight enables a user to determine and identify the members (3, 4) of a lighting system (2) individually, by directing his gaze to the member (3, 4) to be detected. The sensor (1) coupled to the line of sight then detects the member (3, 4) and reads out wirelessly an identification of the detected member (3, 4). Operating parameters and possible input commands for the identified member (3, 4) can then be displayed to the user automatically. The input commands comprise commands for manipulating and/or configuring the identified member (3, 4) via an input device (6).

### FIELD OF THE INVENTION

The present invention relates to a system and a method for selecting and identifying members of a lighting system, in particular an operating device and/or a lighting means of the lighting system. The system and the method of the present invention are based, in particular, on the use of a sensor coupled to the viewing direction.

### BACKGROUND

The prior art discloses different approaches for selecting members of a lighting system. In this case, the members of a lighting system are operating devices or lighting means, for example. Such members must be individually selected and controlled, if appropriate for installation, maintenance or configuration.

Lighting means of FL lamps are typically removed. In addition, the prior art also discloses lamps which generate and reproduce an identification code by modulating their lighting spectrum, which identification code can be read, for example, by means of an optical sensor in order to identify a lamp.

However, these previously known approaches are too complicated and time-consuming, in particular if they have to be used for a multiplicity of members of a lighting system, for example in an office building. In addition, at least some of the members of a lighting system are usually arranged on high ceilings or at locations which are otherwise difficult to access, with the result that it may be difficult to directly access particular members in order to configure them.

Furthermore, the above-mentioned reproduction of an identification code by modulating the lighting spectrum of the lighting means of a lighting system, for example, is complicated in terms of control technology as soon as there is a large number of lighting means. In addition, a special control system must be used. Said approach also cannot be easily implemented for conventional lamps.

The present invention proposes a system and a method with the object of eliminating or at least reducing the above-mentioned disadvantages of the prior art. In particular, the object of the present invention is to make it possible to select and identify members of a lighting system in a simplified manner and to simplify the manipulation and/or configuration of a multiplicity of members.

The present invention achieves the objects mentioned by means of a system and a method according to the appended independent claims. The dependent claims advantageously develop the core concept of the invention.

### SUMMARY

In particular, the present invention relates to a system for selecting members of a lighting system, which has a lighting system containing at least one member, for example an operating device and/or a lighting means, a sensor which is coupled to the viewing direction and is configured to detect a member, the sensor which is coupled to the viewing direction being configured to wirelessly read an identification of the detected member.

The sensor which is coupled to the viewing direction comprises, for example, a visual sensor, an IR sensor or another suitable sensor with directivity, the sensor being coupled or being able to be coupled to the viewing direction of a user. For this purpose, the sensor may be installed, for example, in a suitable apparatus, for instance glasses or a helmet, with the result that it is always oriented according to the viewing direction of the user. The user of the system can now detect a member of the lighting system simply by directing his gaze at this member and can therefore select and simultaneously identify this member. As a result of this quick and simple selection and identification process, it is possible to select a multiplicity of members in succession in a short time and to configure them, for example. This considerably simplifies, for instance, the installation or maintenance of lighting systems in buildings since even members which are difficult to access can be easily selected, in particular.

As a result of the identification being wirelessly read, the user simply receives the information needed to configure and/or manipulate the detected member. The identification can be read either directly from the detected member, for example using RFID, or from a marking, for example a number code, a character code or a barcode, on the member, which marking is in the viewing angle of the user or the sensor which is coupled to the viewing direction. Alternatively, the identification can be read from a server, for example, via a wireless network on the basis of the visual or other features of the detected member (in particular its position/coordinates in space, its arrangement in the lighting system, its shape, size or other characteristic features). For this purpose, a plan of all members of the lighting system may be stored on a server.

The at least one member is advantageously provided with a 1D or 2D barcode, and the sensor which is coupled to the viewing direction is configured to read the barcode.

A multiplicity of items of information and parameters may be coded in the barcode and are available to the user quickly and easily (only by directing his gaze at a member). For example, an identification of the member, a control number and/or configuration parameters may be coded.

The sensor which is coupled to the viewing direction is advantageously a visual sensor or an IR sensor.

The system advantageously also has an input apparatus for presenting information and for inputting commands for manipulating and/or configuring the identified member.

The user of the system may automatically be presented with the member's identification on the input apparatus and can transmit the commands to the detected member in a wireless or wired manner on the basis thereof.

The input apparatus advantageously has at least one touch-sensitive screen.

In this case, the user can detect and select a member by directing his gaze at the lighting system. This can be implemented, for example, by means of glasses or a helmet or a helmet camera belonging to the user. The touch-sensitive screen, for example a tablet computer, displays the identification of the detected member and possible commands and control options. The user can input commands using both hands without any problems.

The input apparatus is advantageously wirelessly connected to the touch-coupled sensor.

Alternatively, the input apparatus is integrated and connected, with the sensor which is coupled to the viewing direction, in an apparatus.

In this case, the sensor which is coupled to the viewing direction is advantageously integrated in glasses, the glasses are configured to present the input apparatus to a user as augmented reality, and the input apparatus can be operated by means of gesture control by the user.

This exemplary embodiment makes it possible for the user to select and configure or operate members of a lighting system in a particularly simple and quick manner.

The system advantageously also has a control apparatus for receiving the commands for manipulating and/or configuring the identified member from the input apparatus and for controlling the detected member on the basis of the received commands.

The control apparatus is advantageously connected to the lighting system in a wireless and/or wired manner, for example via a DALI bus.

The control apparatus is advantageously wirelessly connected to the input apparatus via a WLAN network or Bluetooth.

The manipulating and/or configuring commands advantageously contain: commands for allocating a logical address, for example a manufacturer's address, to the identified member or commands for carrying out maintenance operations on the identified member.

Operating parameters are advantageously automatically received from the input apparatus and displayed for an identified member.

The user can therefore quickly react to possible deviations of the operating parameters.

The operating parameters advantageously comprise the operating period of a lighting means and/or temperatures of an operating device.

The present invention also relates to a method for selecting members of a lighting system, which has the steps of detecting at least one member of a lighting system, for example an operating device and/or a lighting means, using a sensor which is coupled to the viewing direction, and wirelessly reading an identification of the detected member by means of the sensor which is coupled to the viewing direction.

The method can be carried out by the system according to the invention. The method enables the same advantages as those described for the system.

### BRIEF DESCRIPTION OF THE DRAWINGS

The present invention is now described in more detail with reference to the attached figures.

FIG. 1 shows an overview of the fundamental concept of the present invention.

FIG. 2 shows a schematic view of a system of the present invention.

FIG. 3 shows a schematic view of a system of the present invention.

FIGS. 4-7 show exemplary uses of the present invention.

### DETAILED DESCRIPTION OF THE PREFERRED EMBODIMENTS

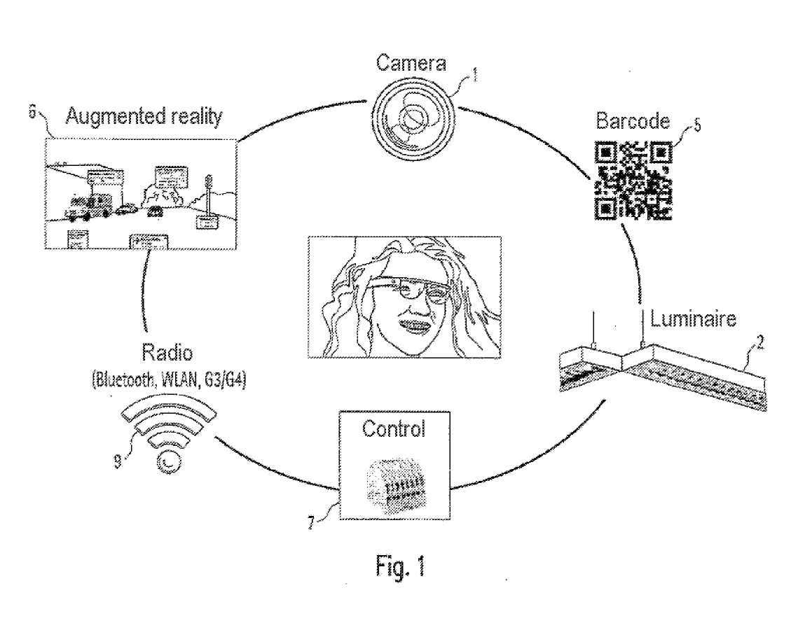

FIG. 1 clearly shows the fundamental concept of the present invention. The concept is based on a provided system and a method which is accordingly carried out.

The system of the present invention comprises a sensor 1 which is coupled to the viewing direction and can be used to detect and thus select at least one member 3, 4 of a lighting system 2. The sensor 1 which is coupled to the viewing direction is, for example, a camera, a visual sensor, an IR sensor or another sensor with directivity. The sensor 1 is configured in such a manner that it is associated with or can be coupled to the viewing direction of a user. The sensor 1 may be coupled, for example, to the viewing direction of a human user by virtue of it being integrated in glasses (as illustrated, for example, in FIG. 1, for example glasses similar to the “Google glass” project), a helmet camera or a similar apparatus preferably worn by the user on his head.

The sensor 1 which is coupled to the viewing direction is suitable for detecting a member 3, 4 of the lighting system 2. The sensor 1 which is coupled to the viewing direction is also configured to wirelessly acquire an identification of the detected member. For example, the sensor 1 which is coupled to the viewing direction may read a 1D or 2D barcode 5 assigned to a detected member 3, 4 of the lighting system 2. However, the sensor 1 which is coupled to the viewing direction may also detect and identify a detected member 3, 4 of a lighting system 2 using its shape, size, position in space or arrangement in the lighting system. For this purpose, the sensor 1 which is coupled to the viewing direction may receive the information required for identification, for example its current location, the immediate environment and/or all installed members 3, 4 of a lighting system 2 or all members 3, 4 in the environment of the sensor 1, in a wireless manner via a network 9, for example.

The lighting system 2 may be controlled, manipulated and/or configured using a control apparatus 7. The commands for controlling the lighting system 2, in particular for manipulating and/or configuring the detected member 3, 4, can be input by the user using an input apparatus 6. In this case, the input apparatus 6 is advantageously wirelessly connected to the sensor 1 which is coupled to the viewing direction, but may also be permanently connected to said sensor or even integrated in an apparatus.

For example, the input apparatus may be presented virtually as an augmented reality, as indicated in FIG. 1, on the lenses of glasses containing the sensor 1 which is coupled to the viewing direction. In this case, this virtual input apparatus can be superimposed on the reality perceived by the user through the lenses. Commands for manipulating and/or configuring the detected member 3, 4 can be stipulated, for example by means of gesture control by the user, and can be wirelessly transmitted to the control apparatus 7 via a network 9 in order to control the identified member 3, 4.

The user of a system of the present invention can therefore detect, that is to say select, a member 3, 4 of the lighting system 2 merely by directing his gaze at this member 3, 4 and can wirelessly read an identification of the member 3, 4.

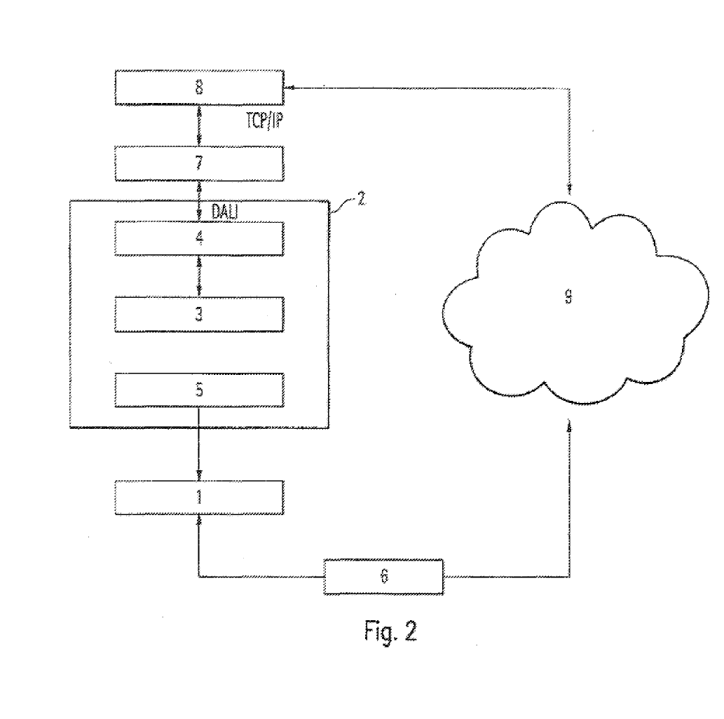

FIG. 2 shows a schematic illustration of a system of the present invention. The system comprises a lighting system 2 having at least one member 3, 4. A member 2, 4 is a lighting means 3 or an operating device 4, for example. The lighting system 2 may contain a multiplicity of members 3, 4, in which case a lighting means 3 is assigned to each operating device 4 and is connected to the latter, for example. However, a plurality of lighting means 3 may also be operated by one operating device 4. The lighting system 2 is advantageously connected to a control apparatus 7 via an interface. The interface may be wired or wireless. For example, the control apparatus 7 and the operating device 4 are connected via a DALI interface, that is to say a DALI bus.

The lighting system 2 or each member 3, 4 of the lighting system 2 is advantageously provided with a readable marking 5, for example a barcode, a number code or most preferably a 1D or 2D barcode 5. The barcode 5 can be read by the sensor 1 which is coupled to the viewing direction. For this purpose, the sensor 1 which is coupled to the viewing direction may contain means for decrypting the 1D or 2D barcode 5, such as a microprocessor, in order to independently identify the detected member 3, 4 from the barcode 5. However, the sensor 1 which is coupled to the viewing direction may also be wirelessly connected to a server 8, for example, via a network 9 in order to acquire an identification of the member 3, 4 detected by it on the basis of the barcode 5 which has been read.

The sensor 1 which is coupled to the viewing direction may be integrated in a cloud, for example, and/or may be connected to a server 8 via a WLAN network, a mobile radio network, a UMTS network, an LTE network or a Bluetooth network. Information relating to all members 3, 4 of the lighting system 2 may be stored on the server 8. These include features such as shape, size, luminous intensity, luminous color, position in space, orientation, arrangement in the lighting system, connected members or the like. The server 8 is connected to the control apparatus 7 in either a wired or wireless manner, preferably via a TCP/IP interface.

The sensor 1 which is coupled to the viewing direction is also connected to an input apparatus 6. The connection may be either wired or wireless. However, the sensor 1 which is coupled to the viewing direction and the input apparatus 6 may also be integrated in a single apparatus.

In one example, the sensor 1 which is coupled the viewing direction is installed in a helmet camera belonging to the user. The input apparatus may then be, for example, a tablet computer or another apparatus having at least one touch-sensitive screen. In this case, the input apparatus 6 is wirelessly connected to the sensor 1 which is coupled to the viewing direction.

In another example, the input apparatus 6 is a virtual input apparatus which is projected onto lenses of glasses in order to generate an augmented reality for a user. In this example, the sensor 1 which is coupled to the viewing direction is likewise integrated in the glasses.

A user can use the input apparatus 6 of the system to transmit commands for manipulating and/or configuring the lighting system 2, in particular the detected and identified member 3, 4, to the control apparatus 7 or else can transmit said commands directly to the detected member 3, 4.

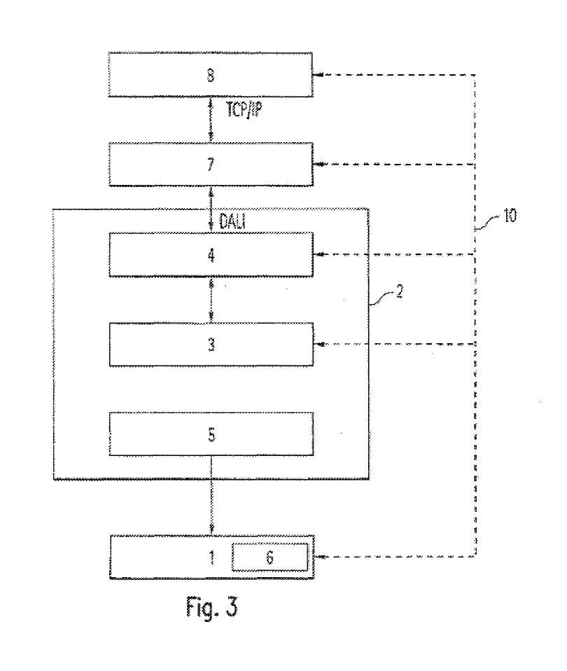

The control apparatus 7 can control the lighting system 2, in particular the selected member 3, 4, on the basis of the received commands. However, the selected member 3, 4 can also be controlled directly, as illustrated in FIG. 3, for example. In FIG. 3, each member 3, 4 and also the control apparatus 7 are provided with a suitable Bluetooth device in order to communicate with the sensor 1 which is coupled to the viewing direction or the input apparatus 6 via a Bluetooth network 10. In FIG. 3, the input apparatus is illustrated only by way of example as being integrated in an apparatus with the sensor 1.

Manipulating and/or configuring commands may comprise, for example, the allocation of a logical address, for instance a manufacturer's address of the operating device. However, simpler commands such as on/off, brighter/darker etc. may also be input. The system can also provide different rights with regard to the configuration and/or manipulation of the lighting system 2 for different users. A user must then, for example, first of all log on to the input apparatus 6 and/or the sensor 1 which is coupled to the viewing direction, for example by inputting a user identification. The corresponding rights can be wirelessly read from a server 8, for example, according to the user identification or may be locally stored. For example, different rights may be allocated for service personnel, installation personnel or normal users. A normal user can transmit only on/off and brighter/darker commands, for example, whereas more extensive configurations, for example commands for carrying out maintenance operations or for allocating logical addresses of the identified member 3, 4, are available for service personnel, for example.

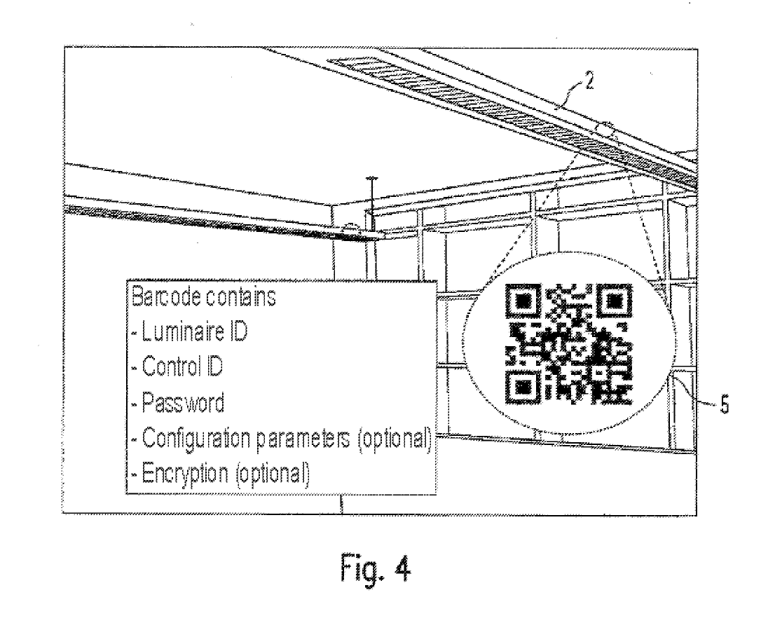

FIG. 4 shows an exemplary use of the present invention. The image detail in FIG. 4 illustrates the viewing direction of a user or the sensor 1 which is coupled to the viewing direction. It can be seen in FIG. 4 that a lighting system 2 is provided with a barcode 5 which can be detected and read by directing the sensor 1 which is coupled to the viewing direction at the barcode 5. In the example from FIG. 4, the input apparatus 6 is an augmented reality which is inserted into the field of view for the user, for example using projection glasses. The barcode 5 contains, for example, information relating to an identification number of the lighting system 2, a control number, a password and configuration parameters. Operating parameters, for example the operating period of the associated lighting means, temperatures in a detected operating device 4 or other operating parameters, can be automatically displayed in the input apparatus 6 when a member 3, 4 is detected and identified by the sensor 1 which is coupled to the viewing direction.

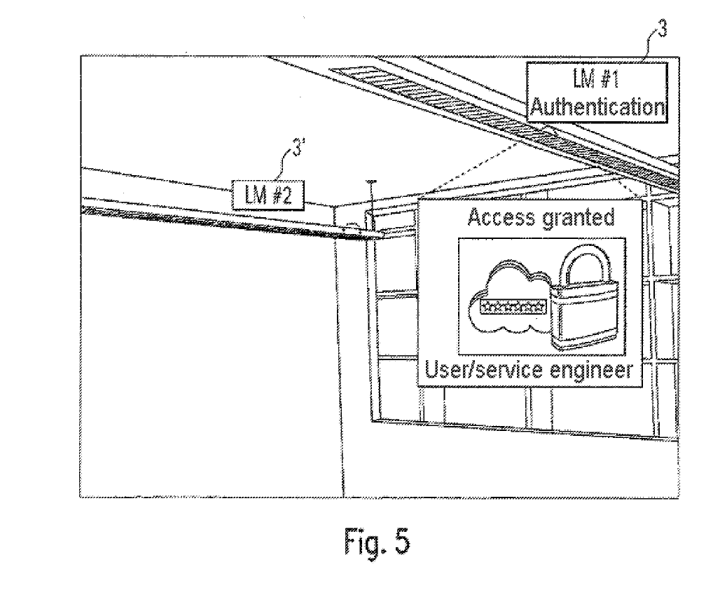

As shown in FIG. 5, provision may be made for an access authorization of the user to first of all be queried for the detected member 3, 4. For example, only a particular group of users may gain access for a member 3, 4 in order to read information such as operating parameters, for example, and carry out configurations. For example, service personnel and/or installation personnel may gain access for the purpose of maintaining and/or configuring the members 3, 4, whereas other users can carry out only basic operations such as ON/OFF.

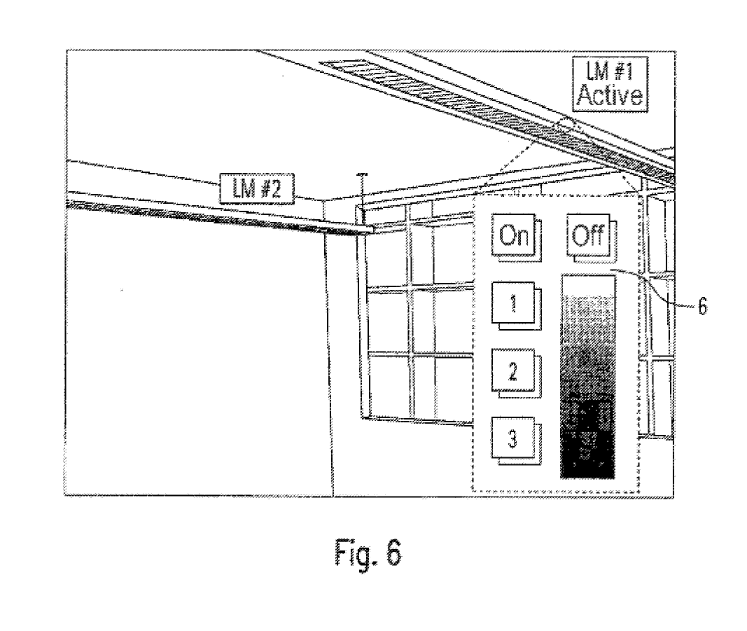

FIG. 6 shows, for example, how the input apparatus 6 can be used to input fundamental commands for manipulating and/or configuring the lighting system 2, in particular the detected member 3, 4. The commands may initiate, for example, the switching-on (on), the switching-off (off), the increasing or reduction of the brightness of the lighting system 2 (1, 2 or 3, or in an infinitely variable manner as a control slider). The commands can be input, for example, by means of gesture control (in particular if an augmented reality is used as the input apparatus 6) or using a touch-sensitive screen.

The commands which have been input are then transmitted to the control apparatus 7 of the lighting system 2 in a wired or wireless manner. In this case, the commands can also first be interpreted by a server 8 and can be forwarded to the control apparatus 7, thus making it possible to adjust the system to different control apparatuses 7. The input apparatus 6 is advantageously provided with an antenna for wirelessly transmitting commands and for receiving the detection and identification of the members 3, 4 from the sensor 1 which is coupled to the viewing direction.

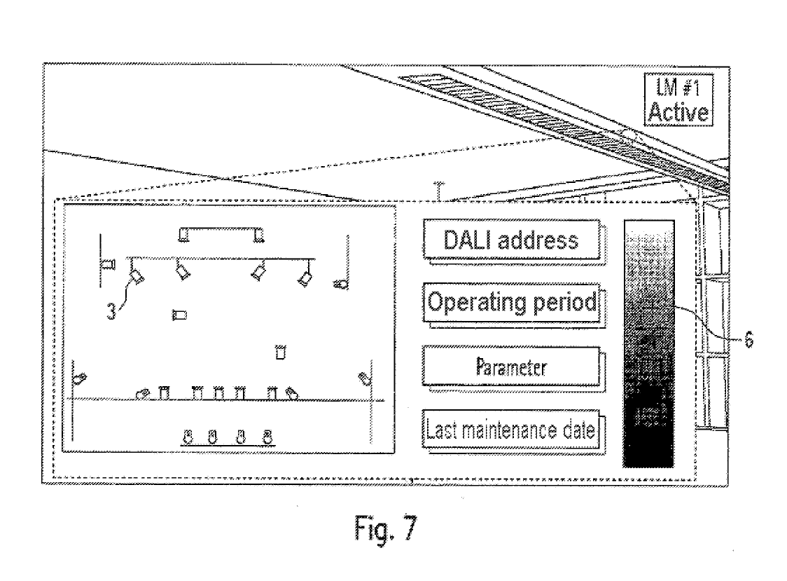

FIG. 7 shows an example in which different members 3, 4 of a lighting system 2 are indicated and in which operating parameters for a detected member or for all members are automatically transmitted and displayed. The operating parameters may contain a DALI address, the operating period, other parameters such as a temperature in the operating device 4 or the lighting means, an applied voltage or a flowing current or the last maintenance date of at least one member 3, 4. Maintenance information which has already been effected may also be indicated. The above-mentioned parameters can also be displayed only to a particular group of users, for example service personnel.

Overall, a user of the system or method according to the invention can therefore easily individually detect and identify the members 3, 4 of a lighting system 2 by means of a sensor 1 which is coupled to the viewing direction by only directing his gaze at the respective member 3, 4. Operating parameters and possible input commands for the identified member 3, 4 are then optionally automatically displayed for the user, on the basis of which the user can then wirelessly transmit commands for manipulating and/or configuring the identified member 3, 4 to a control apparatus 7 by means of an input apparatus 6. Different networks can be used for the wireless connection. In principle, wired communication between the sensor 1 which is coupled to the viewing direction and a control apparatus 7 for the lighting system 2 is also conceivable in this case. With the system according to the invention, it is simple for the user to select the desired members 3, 4 from a multiplicity of members, for example in an office building, even if the members 3, 4 are installed in an unfavorable manner and are therefore difficult to reach. This considerably simplifies maintenance or control of the members 3, 4 of the lighting system. This achieves a significant improvement with respect to the known prior art.

1. A system for selecting members of a lighting system (2), comprising
a lighting system (2) comprising at least one member (3, 4)
a sensor (1) which is coupled to a viewing direction and is configured to detect the at least one member (3, 4), the sensor (1) which is coupled to the viewing direction being configured to wirelessly read an identification of the detected member (3, 4).

2. The system as claimed in claim 1, wherein the at least one member (3, 4) is provided with a 1D or 2D barcode (5), and the sensor (1) which is coupled to the viewing direction being configured to read the barcode (5).

3. The system as claimed in claim 1, wherein the sensor (1) which is coupled to the viewing direction being a visual sensor or an IR sensor.

4. The system as claimed in claim 1, further comprising
an input apparatus (6) for presenting information and for inputting commands for manipulating and/or configuring the identified member (3, 4).

5. The system as claimed in claim 4, wherein the input apparatus (6) comprises at least one touch-sensitive screen.

6. The system as claimed in claim 5, wherein the input apparatus (6) is wirelessly connected to the touch-coupled sensor (1).

7. The system as claimed in claim 4, wherein the input apparatus (6) is integrated and connected, with the sensor (1) which is coupled to the viewing direction, in an apparatus.

8. The system as claimed in claim 7, wherein the sensor (1) which is coupled to the viewing direction is integrated in glasses, the glasses being configured to present the input apparatus (6) to a user as augmented reality, and the input apparatus (6) being able to be operated by means of gesture control by the user.

9. The system as claimed in claim 4, further comprising
a control apparatus (7) for receiving the commands for manipulating and/or configuring the identified member (3, 4) from the input apparatus (6) and for controlling the detected member (3, 4) on the basis of the received commands.

10. The system as claimed in claim 9, wherein the control apparatus (7) is connected to the lighting system (2) in a wireless and/or wired manner, for example via a DALI bus.

11. The system as claimed in claim 10, wherein the control apparatus (7) is wirelessly connected to the input apparatus (6) via a WLAN network (9) or Bluetooth (10).

12. The system as claimed in claim 9, wherein the manipulating and/or configuring commands containing: commands for allocating a logical address to the identified member (3, 4) or commands for carrying out maintenance operations on the identified member (3, 4).

13. The system as claimed in claim 4, wherein operating parameters are automatically received from the input apparatus (6) and displayed for an identified member (3, 4).

14. The system as claimed in claim 13, wherein the operating parameters comprising the operating period of a lighting means (3) and/or temperatures of an operating device (4).

15. A method for selecting members of a lighting system (2), comprising the steps of
detecting at least one member (3, 4) of a lighting system, using a sensor (1) which is coupled to a viewing direction,
wirelessly reading an identification of the detected member (3, 4) by means of the sensor (1) which is coupled to the viewing direction.
